(19) United States
(12) Patent Application Publication
(10) Pub. No.: US 2024/0335969 A1
(43) Pub. Date: Oct. 10, 2024

(54) SLICING MACHINE AND METHOD FOR SLICING PRODUCT CALIBRES

(71) Applicant: MULTIVAC SEPP HAGGENMÜLLER SE & CO. KG, Wolfertschwenden (DE)

(72) Inventors: Tom STACHEL, Kempten (DE); Kai EISENACH, Wetter (DE)

(73) Assignee: MULTIVAC SEPP HAGGENMÜLLER SE & CO. KG, Wolfertschwenden (DE)

(21) Appl. No.: 18/627,216

(22) Filed: Apr. 4, 2024

(30) Foreign Application Priority Data
Apr. 5, 2023 (DE) 102023108712.6

(51) Int. Cl. B26D 7/30; B26D 5/00; B26D 7/06

(52) U.S. Cl. CPC B26D 7/30; B26D 5/00; B26D 7/0625; B26D 2210/02

(57) ABSTRACT

A slicing machine for slicing a predetermined number of product calibres into slices and producing portions from the slices includes a cutting unit for separating the slices from the predetermined number of product calibres, a feeding unit for feeding multiple product calibres to the cutting unit, a buffer unit to receive the multiple product calibres, a weight detection unit to detect a weight of each of the multiple product calibres received in the buffer unit, and a controller to obtain from the weight detection unit the weight of each of the multiple product calibres and control the buffer unit to feed the predetermined number of product calibres from the multiple product calibres to the feeding unit such that the weight of each of the predetermined number of product calibres has at most a predetermined deviation from the weight of each other of the predetermined number of product calibres.

### CROSS-REFERENCE TO RELATED APPLICATIONS

This application claims foreign priority benefits under 35 U.S.C. § 119(a)-(d) to German patent application number DE 102023108712.6, filed Apr. 5, 2023, which is hereby incorporated by reference herein in its entirety.

### TECHNICAL FIELD

The disclosure relates to slicing machines, in particular “slicers”, with which strands of an only slightly compressible product such as sausage or cheese are sliced in the food industry. The disclosure further relates to a method for operating such a slicing machine.

### BACKGROUND

Since these strands can be produced with a cross-section that retains its shape and dimensions well over its length, i.e. is substantially constant, they are called product calibres.

In most cases, several product calibres arranged in parallel with one another on individual tracks are cut open at the same time by the same knife, which moves in a transverse direction to the longitudinal direction of the product calibres, cutting off one slice at a time in one pass.

The product calibres are pushed forwards by a feed conveyor of a feeding unit in the direction of the blade of the cutting unit, usually on an inclined downwards feed conveyor, and are each fed through the product openings of a plate-shaped, so-called cutting frame, at the front end of which the projecting part of the product calibre is cut off as a slice by the blade immediately in front of the cutting frame.

During slicing, the product calibres are usually held at their rear end facing away from the cutting frame by a gripper, which is equipped with corresponding gripper claws to prevent uncontrolled downwards movement of the product calibres.

It is generally known that product calibres can have fluctuations in weight. This occurs particularly frequently when the product calibres consist of natural products, such as matured meat, for example bacon, or cheese or similar. If two or more product calibres are sliced at the same time, the problem can therefore often arise in such a manner that a higher number of substantially equal-weight portions can be sliced on one track, namely the track on which the heavier product calibre is located, than on another track on which a lighter product calibre is located. In a two-track slicing machine, for example, this can lead to a 50% drop in performance if one track is omitted, as the slicing machine is usually only reloaded once all product calibres have been completely sliced except for one remaining piece. So-called empty packs are then usually produced on the inactive track, which must subsequently be sorted out as rejects.

So-called “picker” systems or belt feeders with two-track buffer bands have already been proposed to overcome this problem, but these solutions are comparatively expensive, have a high space requirement and are prone to faults and require maintenance due to their design complexity. Nor do these systems solve the problem of power leg breakage on the slicing machine described above.

### SUMMARY

It is therefore the object according to the disclosure to provide a slicing machine, in particular a slicer, which can remedy this situation, in particular by means of a solution in which the product calibres can be sliced with a high throughput and the production of empty packaging can be kept to a minimum.

Furthermore, the object of the disclosure is to provide a corresponding method.

A generic slicing machine, such as a slicer, for preferably simultaneously slicing a predetermined number of product calibres lying in parallel, in particular next to one another, in different tracks into slices, wherein the predetermined number is at least two, and for producing, preferably shingled or stacked, portions from the slices typically comprises
a cutting unit with a blade, which is movable in a cutting plane, in particular rotatable, for separating the slices from the product calibre,
a feeding unit with a feed conveyor for feeding the product calibres to the cutting unit along a feed direction,
in particular a discharge unit with a conveyor, preferably a portioning band, for the slices, and
a controller for controlling moving parts of the slicing machine.

According to the disclosure, the slicing machine further comprises a buffer unit, which is arranged on or upstream of the feeding unit and is configured to receive a plurality of product calibres, wherein a weight detection unit is associated with the buffer unit, which is configured to detect a weight of the product calibres received in the buffer unit, wherein the buffer unit and the weight detection unit are operationally connected, in particular by data technology, to the controller, and wherein the controller is configured to:
obtain from the weight detection unit a product calibre weight of each product calibre stored in the buffer unit, and
control the buffer unit in such a manner that it feeds the predetermined number of product calibres to the feeding unit immediately one after the other or substantially simultaneously in such a manner that the product calibre weights of the predetermined number of product calibres have at most a predetermined deviation from one another.

According to the disclosure, the problem of different product calibre weights is already taken into account when loading the feeding unit of the slicing machine and the product calibres are fed from the buffer unit in such a manner that the predetermined number of product calibres which are sliced, preferably simultaneously, have a product calibre weight which is as similar as possible. As a result of this, substantially the same number of portions of approximately the same weight can be sliced from each product calibre during the slicing of the predetermined number of product calibres, so that a drop in output at one or more tracks and thus the production of empty packs can be significantly reduced or at best completely prevented.

Particularly when slicing product calibres from natural products, such as matured meat or cheese or similar, the product calibres almost never have exactly the same weight. Certain deviations or tolerances are therefore also permissible with regard to the weight of the individual sliced portions, within which portions with small differences in weight are still considered to be “substantially equal in weight”. It is therefore proposed that the predetermined deviation of the product calibre weights of the at least two product calibres is preferably at most approximately ±4.5%, further preferably at most approximately ±2%. The predetermined deviation can, for example, be based on the weight of the lightest or heaviest product calibre of the predetermined number of product calibres.

Particularly in a case in which the product calibres in the buffer unit have only a very small difference in weight to one another, it may be possible for more than the predetermined number of product calibres to fulfil the above condition with regard to the predetermined deviation of the product calibre weights. According to an exemplary embodiment, it is therefore proposed that the controller is further configured in such a manner that, if the product calibre weights of more than the predetermined number of product calibres have at most the predetermined deviation from one another, the buffer unit is controlled in such a manner that it feeds the predetermined number of product calibres to the feeding unit immediately one after the other or substantially simultaneously in such a manner that the product calibre weights of the predetermined number of product calibres have the smallest possible deviation from one another. As a result, it can be ensured that the product calibres with the most similar weights are always fed from the buffer unit and sliced at the same time.

If product calibres are sliced that have an approximately constant and/or known cross-section (extension in the transverse and/or height direction of the product calibre), for example due to an upstream pressing process and optionally a freezing process or similar, which is regularly the case with bacon, for example, it is generally sufficient if only the product calibre weight of the relevant product calibre is known in order to ensure that a similar number of portions can be sliced from product calibres that are as similar in weight as possible. This functions even if the product calibres have small differences in length to each other, as these can be compensated for by independent controllers of the grippers in the feed direction, for example.

However, if the cross-sections of the product calibres deviate substantially from one another, which can occur, for example, in the case of cheese due to an irregular distribution of holes, it is advantageous if the slicing machine further comprises a further detection unit, which is operationally connected to the controller and is configured to detect at least one further product parameter, in particular a length and/or a volume and/or a shape of the product calibres. The volume may not only be an external volume, i.e. visible from the outside, of the total product calibre, but the internal volume may also be taken into account, for example, in the case of cheese, the air holes contained therein, which accordingly have no substantial weight. The length and/or the volume and/or the shape can be detected, for example, by an optical sensor provided on the slicing machine in the region of the buffer unit, for example an X-ray sensor, or the like. Preferably, the controller is further configured to control the buffer unit as a function of the at least one further product parameter, so that, for example, the predetermined number of product calibres can also be fed taking into account the at least one further product parameter.

If the volume is not recorded directly, the volume of a product calibre can be calculated from the length and cross-section, i.e. the height and width, of the product calibre, for example. Together with the product calibre weight, the density of a relevant product calibre can in turn be determined from this and the weight of the slices separated from the product calibre or the portions formed from the slices can be estimated, and this can be taken into account by the controller of the slicing machine.

It is further conceivable that the product calibres must first be reduced or subdivided before slicing, for example in the width direction, so that the sliced slices have the desired dimensions, in particular with regard to a slice width and/or a slice height. In practice, this is also the case with cheese, for example, which is often produced in so-called “Euro blocks”, which, if they are to be sliced as product calibres, must first be divided into several product calibre parts, preferably of the same weight. According to an exemplary embodiment, the slicing machine can therefore further comprise a cutting device, which is operatively connected to the controller and is configured to cut the product calibres, in particular in the longitudinal direction, into a plurality of product calibre parts, wherein the cutting device preferably comprises at least one, preferably at least two, cutting elements, for example cutting blades, which are adjustable in the transverse direction. The cutting device is preferably arranged upstream of the buffer unit.

The controller can preferably be further configured to control the cutting device as a function of the at least one further product parameter, which is detected by the further detection unit, so that the product calibres can be cut into product calibres of as equal a weight as possible after the weight and volume have been detected, before they are buffered in the buffer unit. This is also highly relevant in connection with the aforementioned cheese euro blocks, as these usually have a rounded cross-section in the edge area. If, for example, the cheese euro block is to be divided into three product calibre parts of approximately the same weight, the outer product calibre parts in the width direction usually have to have a larger dimension in the width direction than the middle product calibre part in the width direction.

When cutting the product calibres in the longitudinal direction, however, product parameter limits must always be taken into account, as the product calibre parts must be neither too large nor too small, in particular in the width direction, since, for example, too large a dimension in the width direction can mean that the slices cut from the product calibre part are no longer compatible with the packaging intended for this purpose. Therefore, the controller can preferably be further configured to control the cutting device as a function of at least one product parameter limit value, in particular a minimum and/or maximum slice width of the slices.

A minimum and/or maximum slice thickness of the slices and/or minimum and/or maximum number of slices, in particular per portion, can also generally be taken into account for cutting and/or buffering and/or feeding the product calibres. The product parameter limit values can, for example, be stored in a storage unit, which comprises the controller and/or can be in signal connection with it.

In principle, the weight of the product calibres can be recorded, for example, by means of a weight recording unit in the form of a scale or similar, which does not necessarily have to be a direct component of the slicing machine, i.e. can also be arranged at a distance from the slicing machine, provided that it is ensured that the product calibre weights are transmitted to the controller of the slicing machine via a corresponding signal connection or similar. This also applies to the other detection unit. However, in order to be able to detect the weight and/or length and/or volume and/or shape of the product calibres, at best directly on the slicing machine itself, the slicing machine may further comprise the weight detection unit and/or the further detection unit, wherein the weight detection unit and/or the further detection unit is preferably arranged upstream of the buffer unit. The weight detection unit can preferably be configured to weigh the product calibres individually.

In principle, the weight detection and/or the detection of the at least one further product parameter could also take place within the buffer unit, wherein then preferably calibre receiving units of the buffer unit, which are each configured to receive a product calibre within the buffer unit, can comprise a corresponding apparatus for detecting the product calibre weight and/or the at least one further product parameter.

In order to be able to load the product calibres preferably automatically into the buffer unit, the slicing machine can further comprise a loading unit, which is arranged upstream of the buffer unit and is configured to load the plurality of product calibres into the buffer unit, in particular through a feed opening of the buffer unit. Preferably, the loading unit can be designed with the weight detection unit and/or the further detection unit to be functionally integrated, in particular as a single piece.

The weight detection unit itself can, for example, be designed as a weighing and/or transport belt. Alternatively, the weight can also be detected by monitoring the current consumption of actuators on the slicing machine, for example electric motors of a feed band or similar.

In order to be able to remove the product calibres preferably automatically from the buffer unit and feed them to the feeding unit, the slicing machine can further comprise at least one removal device, in particular a removal belt and/or a pusher and/or a robot arm, which is configured to remove a relevant product calibre from the buffer unit and convey it in the direction of the feeding unit, in particular onto the feed conveyor of the feeding unit. The removal device, in particular the removal belt and/or the pusher, can preferably be further configured to push the relevant product calibre onto the feeding unit, in particular onto the feed conveyor of the feeding unit, substantially parallel to the feeding direction.

In order to be able to store the largest possible number of product calibres in a comparatively small space and with a high degree of flexibility with regard to feeding into the buffer unit and removal from the buffer unit, the buffer unit can be designed as a paternoster buffer unit comprising a plurality of calibre receiving units, wherein the plurality of calibre receiving units can be displaced in and/or against a direction of rotation, in particular by means of a drive unit of the buffer unit. The direction of rotation can, for example, correspond to a clockwise and/or anti-clockwise displacement direction of the calibre receiving units.

Alternatively, the buffer unit can be designed as a compartment buffer unit, which can comprise a plurality of calibre receiving units, in particular in the form of calibre compartments, wherein the plurality of calibre receiving units can be displaceable in and/or against the vertical direction, i.e. for example the vertical direction, in particular by means of a drive unit of the buffer unit.

In order to be able to ensure that all requirements with regard to maintaining a cold chain are met even if the product calibres are temporarily stored in the buffer unit for a longer period, the buffer unit can preferably comprise a cooling unit, which is configured to passively or actively cool the product calibres contained therein. The cooling unit can only have a passive effect, which can be achieved by ensuring that the buffer unit is sufficiently thermally decoupled from the working environment of the buffer unit, i.e. is provided with appropriate thermal insulation or the like, so that pre-cooled product calibres maintain their temperature for as long as possible or their temperature only rises comparatively slowly towards the environmental temperature of the working environment. Alternatively, the cooling unit can also be designed as an active cooling unit, i.e. can comprise, for example, a corresponding cooling unit or similar in order to cool the product calibres to a predetermined temperature or to maintain them at this temperature.

A method according to the disclosure for slicing, in particular simultaneously, a predetermined number of product calibres into slices, wherein the predetermined number is at least two, and for producing, preferably shingled or stacked, portions from the slices, in particular by means of a slicing machine, preferably a slicer, according to the disclosure, comprises the following steps:
feeding the predetermined number of product calibres in parallel along a feeding direction, in particular by means of a feeding conveyor of a feeding unit,
cutting off slices from the front ends of the product calibres, in particular by means of a cutting unit,
storing the slices, in particular on a portioning belt, to create portions consisting of one or more slices,

wherein
before feeding, a plurality of the product calibres are temporarily stored, in particular in a buffer unit,
a weight of the temporarily stored product calibres is detected, in particular by means of a weight detection unit, and
the feeding of the predetermined number of product calibres takes place immediately one after the other or substantially simultaneously in such a manner that the product calibre weights of the predetermined number of product calibres have at most a predetermined deviation from one another.

It should already be indicated at this point that all statements, advantages and effects described for the slicing machine according to the disclosure also apply to the method according to the disclosure and vice versa.

The predetermined deviation of the product calibre weights of the predetermined number of product calibres can preferably be at most approximately ±4.5%, preferably at most approximately 2%.

Furthermore, preferably, if the product calibre weights of more than the predetermined number of product calibres have at most the predetermined deviation from one another, the predetermined number of product calibres are fed immediately one after the other or substantially simultaneously in such a manner that the product calibre weights of the predetermined number of product calibres have the smallest possible deviation from one another.

According to one embodiment, at least one further product parameter, in particular a length and/or a volume and/or a shape, of the product calibres can furthermore be detected, wherein the buffering and/or the feeding of the product calibres can furthermore be performed as a function of the at least one further product parameter.

Additionally or alternatively, the product calibres can be divided into a plurality of product calibre parts prior to intermediate storage, in particular in the longitudinal direction, preferably by a dividing device, wherein preferably the dividing of the product calibres is controlled as a function of the at least one further product parameter. Furthermore, the cutting of the product calibres can preferably be controlled as a function of at least one product parameter limit value, in particular a minimum and/or maximum slice width of the slices.

### BRIEF DESCRIPTION OF THE DRAWINGS

Embodiments in accordance with the disclosure are described in more detail below by way of example. In the figures:

FIGS. 1a, 1b show a known slicing machine in the form of a slicer according to the prior art in different perspective views, with the feed belt folded up into the slicing position;

FIG. 2a shows a simplified side view of the slicing machine according to the prior art, loaded with a product calibre, which is in a first functional position;

FIG. 2b shows a side view according to FIG. 2a, but with the feed belt folded down into the loading position and the product calibre sliced apart from a remnant calibre piece;

FIG. 3a shows a side view of a slicing machine according to the disclosure, which comprises a buffer unit in the form of a paternoster buffer unit, in which a first run and a second run, viewed in the feed direction, are arranged one behind the other;

FIG. 3b shows an enlarged view of the buffer unit according to FIG. 3a;

FIG. 3c shows a rear view of the slicing machine according to FIG. 3a;

FIG. 3d shows a rear view of the buffer unit of the slicing machine according to FIG. 3a, viewed according to IIID-IIID, as indicated in FIGS. 3a and 3b;

FIG. 4a shows a side view according to FIG. 3a with the difference that a first run and a second run of the buffer unit are arranged next to each other when viewed in the feed direction;

FIG. 4b shows an enlarged view of the buffer unit according to FIG. 4a;

FIG. 4c1 shows a rear view of the slicing machine according to FIG. 4a;

FIG. 4c2 shows a rear view of a slicing machine according to FIG. 4a, wherein, however, the buffer unit is designed as a compartment storage unit, and;

FIG. 5 shows a top view according to V in FIG. 3a, in which a cutting device is represented.

### DETAILED DESCRIPTION

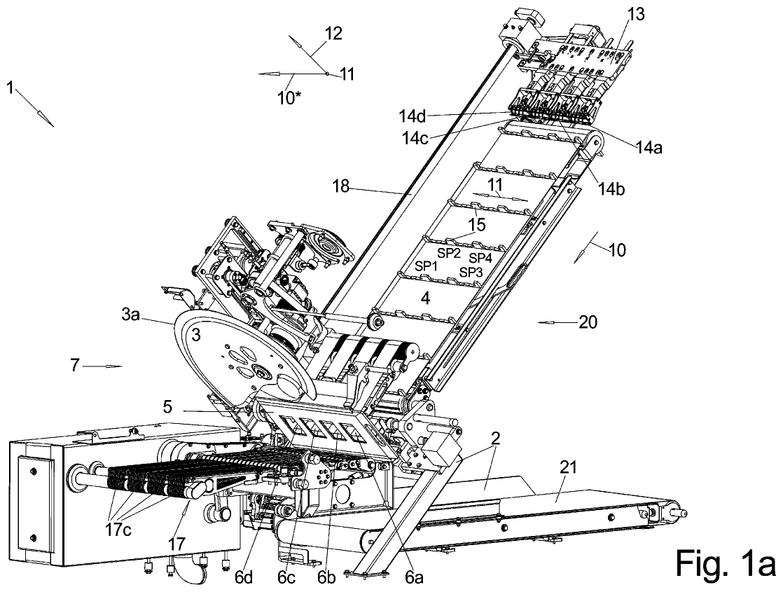

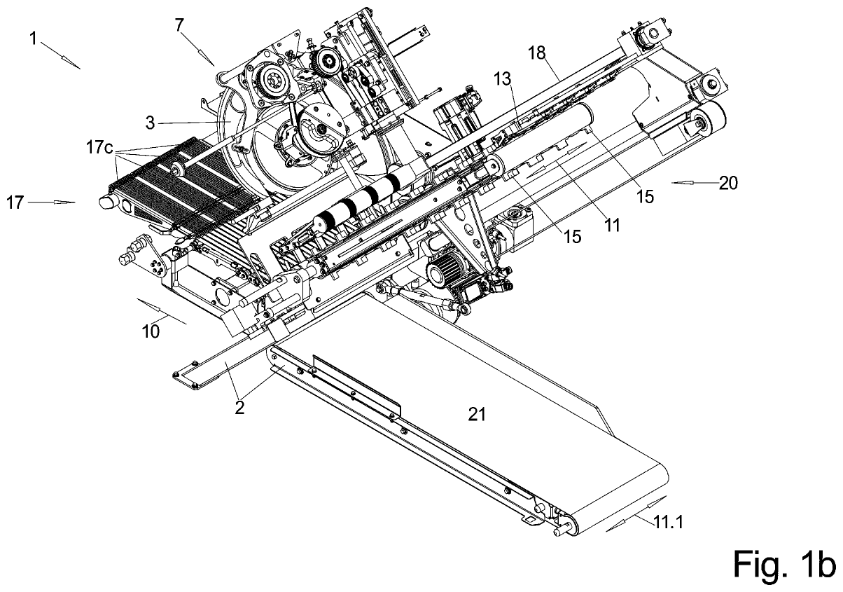

FIGS. 1a, 1b show different perspective views of a multi-track slicer 1 for simultaneously slicing a plurality of product calibres K—which are not represented for reasons of clarity—in each case on a track SP1 to SP4 next to each other, and storing them in shingled portions P each consisting of several slices S with a general direction of travel 10* through the slicer 1 from right to left.

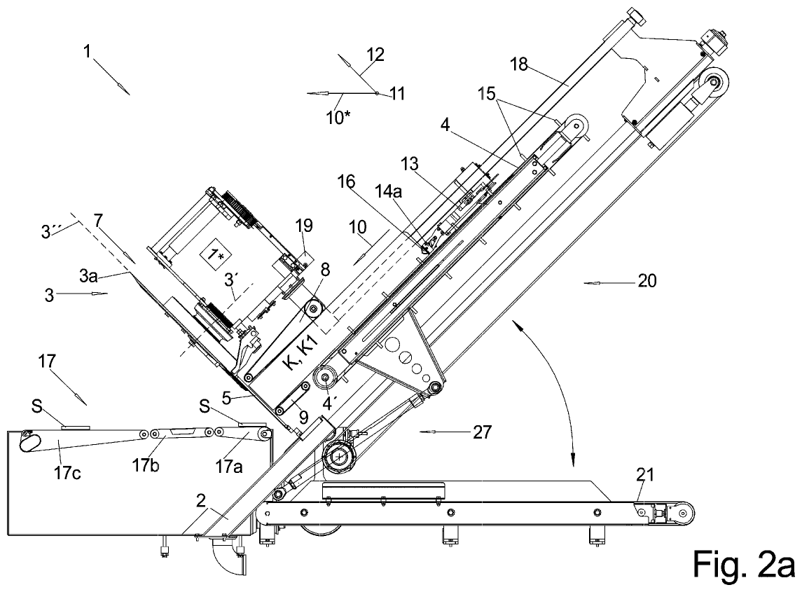

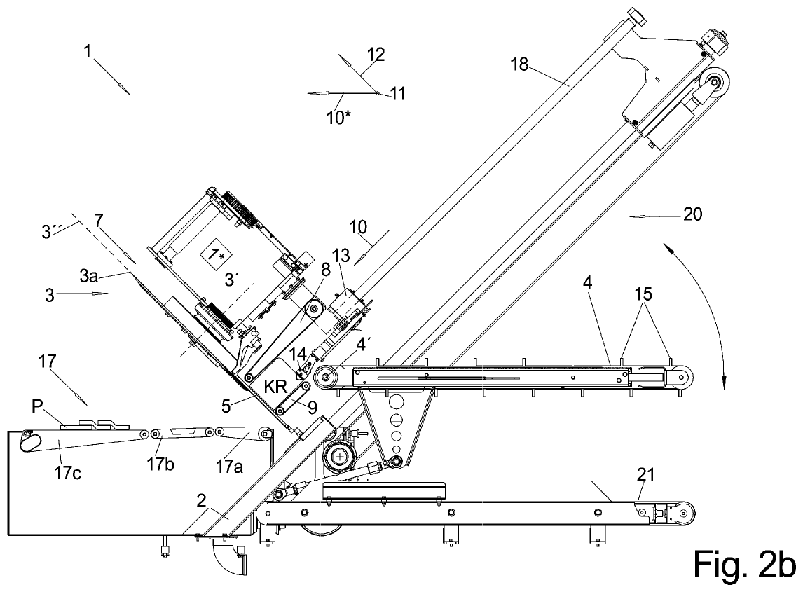

FIG. 2a and FIG. 2b show—with the calibre K inserted—a side view of this slicer 1, omitting covers and other parts not relevant to the disclosure, which are attached to the base frame 2 in the same manner as all other units, so that the functional parts, in particular the conveyor belts, can be seen more clearly. The longitudinal direction 10 is the feed direction of the calibres K to the slicing unit 7 and thus also the longitudinal direction of the calibres K lying in the slicer 1.

It can be seen that the basic structure of a slicer 1 according to the prior art is that a cutting unit 7 with a knife 3 rotating about axis of rotation 3′, in this case a sickle knife 3, is fed with several, in this case four, product calibres K lying transversely to the feed direction 10 next to one another on a feed conveyor 4, with spacers 15 of the feed conveyor 4 between them, by this feeding unit 20, from the front ends of which the rotating knife 3 cuts off a slice S with its cutting edge 3a in each case in one operation, that is to say almost simultaneously.

For slicing the product calibres K, the feed conveyor 4 is in the slicing position shown in FIGS. 1a-2a, which is oblique in side view with a low-lying front end on the cutting side and a high-lying rear end, from which it can be folded down about a pivot axis 20′ extending in its width direction, the first transverse direction 11, which axis is located in the vicinity of the cutting unit 7, into an approximately horizontal loading position as represented in FIG. 2b.

The rear end of each calibre K lying in the feeding unit 20 is held in accordance with FIG. 2a in each case by a gripper 14a-d by positive locking with the aid of gripper claws 16. These grippers 14a-14d, which can be activated and deactivated with regard to the position of the gripper claws 16, are fastened to a common gripper carriage 13, which can be moved along a gripper guide 18 in the feed direction 10. The gripper claws 16 are attached to the gripper 14 in a movable manner, i.e. movable between an engagement position and a release position.

In this case, both the feed of the gripper carriage 13 and of the feed conveyor 4 can be driven in a controlled manner, wherein, however, the actual feed speed of the calibres K is effected by a likewise controlled driven, so-called upper and lower, driven product guide 8, 9 in the form of circulating belts, which engage on the upper side and lower side of the calibres K to be sliced in their front end areas near the cutting unit 7.

The front ends of the calibres K are each guided through a so-called product opening 6a-d of a plate-shaped cutting frame 5, wherein the cutting plane 3″ extends directly in front of the front, obliquely downwards pointing end face of the cutting frame 5, in which the knife 3 rotates with its cutting edge 3a and thus cuts off the protrusion of the calibres K from the cutting goggles 5 as a slice S. The slicing plane 3″ extends perpendicularly to the upper run of the feed conveyor 4 and/or is spanned by the two transverse directions 11, 12 to the feed direction 10.

In this case, the inner circumference of the product openings 6a-d of the cutting edge 3a of the blade 3 serves as a counter-cutting edge.

Since both product guides 8, 9 can be driven in a controlled manner, in particular independently of one another and/or possibly separately for each lane SP1 to SP4, these determine the—continuous or clocked—feed speed of the calibres K through the slicing frame 5.

The upper product guide 8 is displaceable in the second transverse direction 12—which extends perpendicularly to the surface of the upper run of the feed conveyor 4—to adapt to the height H of the calibre K in this direction. Further, at least one of the product guides 8, 9 can be designed to pivot about one of its deflection rollers in order to be able to change the direction of the strand of its guide belt resting against the calibre K to a limited extent.

Below the feed conveyor unit 20 there is usually an approximately horizontally extending remnant piece conveyor 21, which starts with its front end below the cutting frame 5 and immediately below or behind the discharge unit 17 and with its upper run thereon—by means of the drive of one of the discharge conveyors 17 against the direction of travel 10—transports falling remnants to the rear.

The slices S, which are at an angle when they are separated, fall onto a discharge unit 17 which starts below the cutting goggles 5 and extends in the direction of travel 10*, which in this case consists of a plurality of discharge units 17a, b, c arranged one behind the other with their upper runs approximately aligned in the direction of travel 10*, of which the first discharge unit 17a in the direction of travel 10 can be designed as a portioning belt 17a and/or one can also be designed as a weighing unit.

The slices S can arrive at the discharge unit 17 individually and at a distance from one another in the general direction of travel 10* of the products through the machine or, by appropriate control of the portioning belt 17a of the discharge unit 17—the movement of which, like almost all moving parts, is controlled by the controller 1*—form shingled or stacked portions P by stepwise forwards movement of the portioning belt 17a. In that regard, as one skilled in the art would understand, the controller 1*, as well an any other unit, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

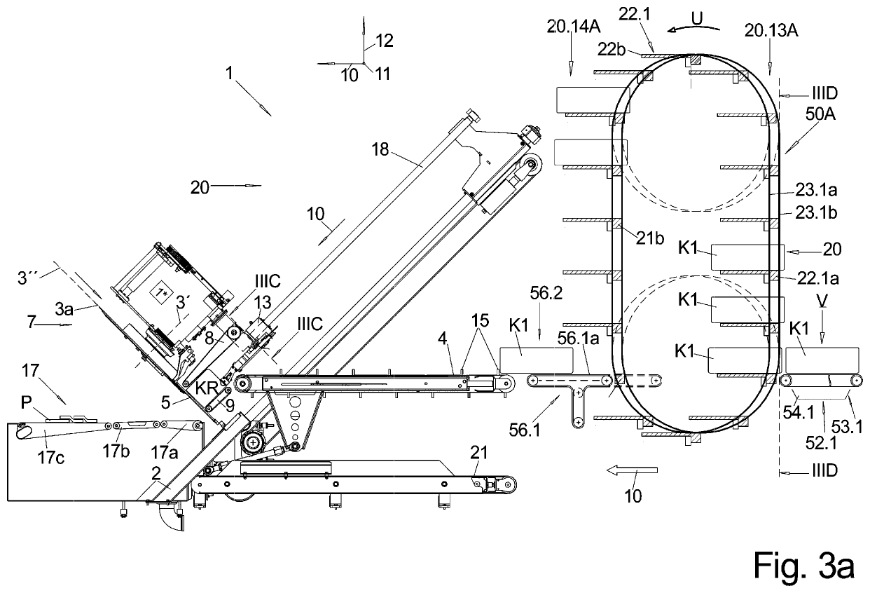

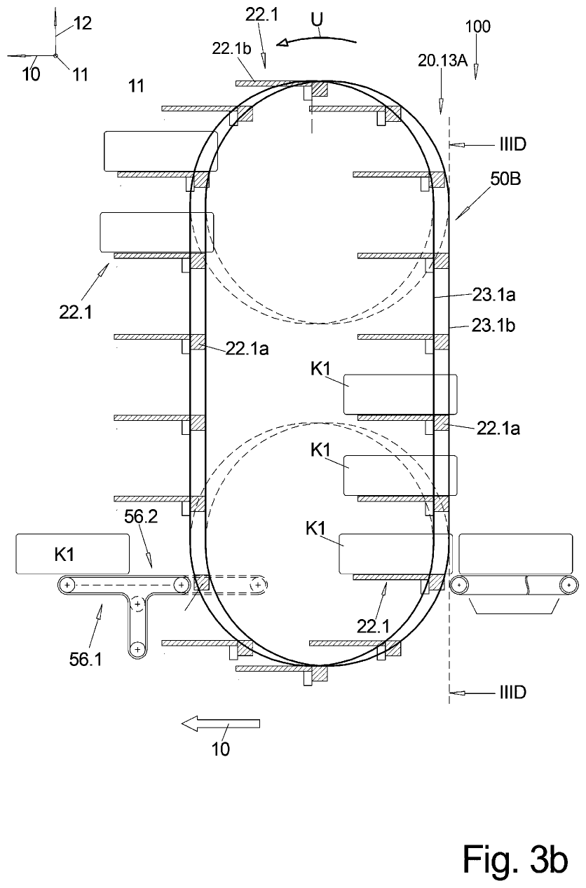

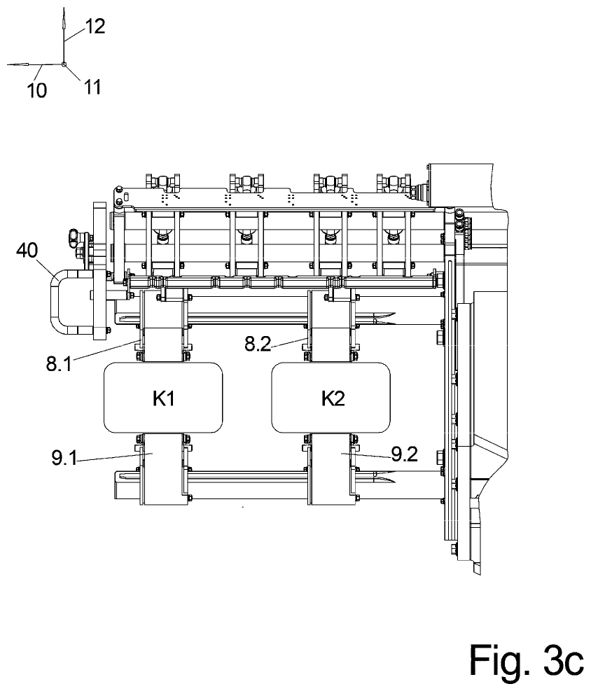

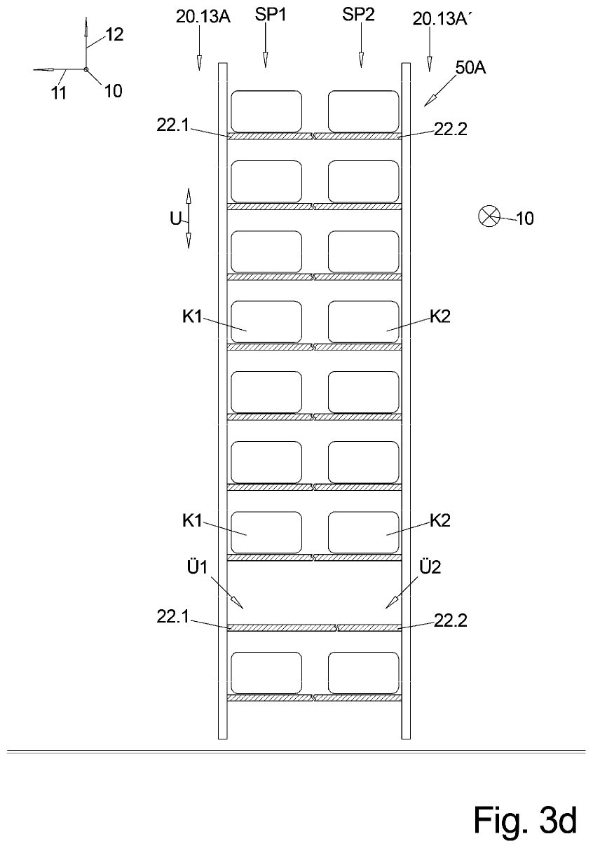

FIG. 3a now shows a slicing machine 1 according to the disclosure, which comprises a buffer unit 50A in the form of a paternoster buffer unit 50A, in which a first run 20.13A and a second run 20.14B are arranged one behind the other in the feed direction 10.

As can be seen in FIG. 3a, the buffer unit 50A is arranged upstream of the feeding unit 20 and comprises a plurality of calibre receiving units 22.1, each of which is configured to receive a product calibre K1. The product calibres K1 are fed to the buffer unit 50A via a loading unit 52.1, which in the exemplary embodiment shown is designed in one piece with a weight detection unit 53.1 in the form of a weighing and transport belt 54.1. By means of the weighing and transport belt 54.1, the product calibre weight of each product calibre K1 can be recorded before loading a relevant product calibre K1 onto a calibre receiving unit 22.1 and stored in, for example, a storage of the controller 1* of the slicing machine 1.

The controller 1* is configured to control the buffer unit 50A in such a manner that it feeds a predetermined number of product calibres K1, K2, in particular two in the exemplary embodiment shown, to the feeding unit 20, in particular to the feed conveyor 4, immediately one after the other or substantially simultaneously, in such a manner that the product calibre weights of the two product calibres K1, K2 have at most a predetermined deviation from one another, for example at most ±4.5%.

For this purpose, the calibre receiving units 22.1 can be moved in and/or against a direction of rotation U by means of a drive unit (not represented) of the buffer unit 50A. The upwards or downwards movement or the movement of the calibre receiving units 22.1 in and/or against the direction of rotation U is effected, for example, by tension elements 23.1a, b, which are coupled to the calibre receiving units 22.1 via their base bodies 22.1a. The product calibres K1 can each rest on substantially plate-shaped designed receiving elements 22.1b, which protrude from the relevant base body 22.1a, as can be seen, for example, in FIGS. 3a and 3b.

As shown in FIG. 3d, the buffer unit 50A is designed with two tracks SP1 and SP2 in the exemplary embodiment shown, wherein the first run 20.13A′ of the second track SP2 is also recognisable in FIG. 3d. Alternatively, however, the buffer unit can also be designed as a single-track buffer unit or as a three-, four- or multi-track buffer unit. The buffer unit 50A can also be configured to feed groups of three, four or more product calibres K of similar weight in such a manner that they can be sliced simultaneously to tracks SP1 to SP4. The description using only two tracks SP1 and SP2 has been chosen here solely to facilitate understanding.

The calibre receiving units 22.2 of the second track SP2 can be designed substantially identically to the calibre receiving units 22.1 of the first track SP1 and can be moved in and/or against the direction of rotation U in an analogous manner, preferably by a further drive unit (not shown) of the buffer unit 50A, which is further preferably drivable independently of the drive unit of the first track SP1. The calibre receiving units 22.2 are configured accordingly to receive the product calibres K2 on the second track SP2.

Each of the calibre receiving units 22.1 or 22.2 can have a unique identifier. When loading a product calibre K1 or K2 onto a relevant calibre receiving unit 22.1 or 22.2, for example, the product calibre weight of the product calibre K1, K2 and the identifier of the corresponding calibre receiving unit 22.1, 22.2 can be stored in a storage unit (not represented) of the controller 1*, so that the controller 1* can call up the product calibre weight of the product calibre K1, K2 located on it for each calibre receiving unit 22.1, 22.2.

As a consequence of this, the controller 1* can control the buffer unit 50A in such a manner that it feeds two product calibres K1 and K2 substantially simultaneously to the feeding unit 20 on the tracks SP1 and SP2, respectively, in such a manner that the product calibre weights of the two product calibres K1, K2 have at most the predetermined deviation from one another.

For this purpose, before the two product calibres K1, K2 are fed onto the feed conveyor 4, only two matching calibre receiving units 22.1 and 22.2 must be moved in the direction of rotation U into a transfer position Ü1 and Ü2 respectively, in which the calibre receiving units 22.1 and 22.2 are approximately at the same height in the height direction 12 as a removal conveyor 56.1 and 56.2 respectively, which is preferably retractable in and against the feed direction 10. The removal belt 56.2 is arranged behind the removal belt 56.1 in the transverse direction 11 and is therefore not visible in FIG. 3a itself and is merely indicated by a reference sign but can correspond to the removal belt 56.1 in terms of its design and function. Therefore, only the function of the removal belt 56.1 will be described in part below. Alternatively, the removal belt 56.1 can also be designed as a two-track removal belt with two or more independently movable tracks.

The product calibre K1 can be transferred from the calibre receiving units 22.1 to the removal belt 56.1, for example, by movement of the removal belt 56.1 against the feed direction 10, so that a conveyor band 56.1a of the removal belt 56.1 can remove the product calibre K1 from the correspondingly positioned calibre receiving unit 22.1 and, after a subsequent return movement in the feed direction 10, transfer it to the track SP1 of the feed conveyor 4. With regard to the removal conveyor 56.2, the transfer of the product calibre K2 can be carried out analogously.

As can be seen, for example, in the rear view according to FIG. 3c, the product calibres K1 and K2 having a similar weight can then be sliced at the same time and guided through an upper and lower product guide 8.1, 8.2 and 9.1, 9.2 in a manner known per se.

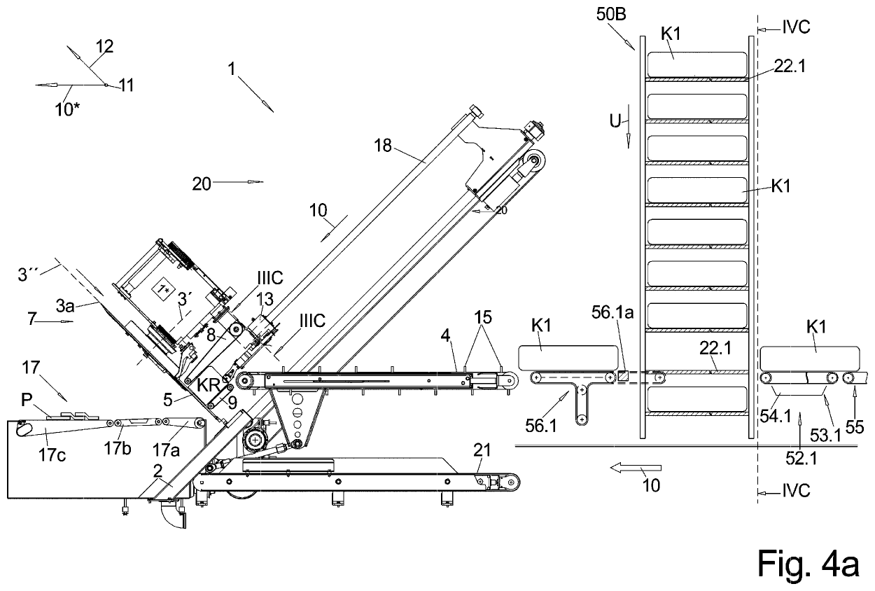

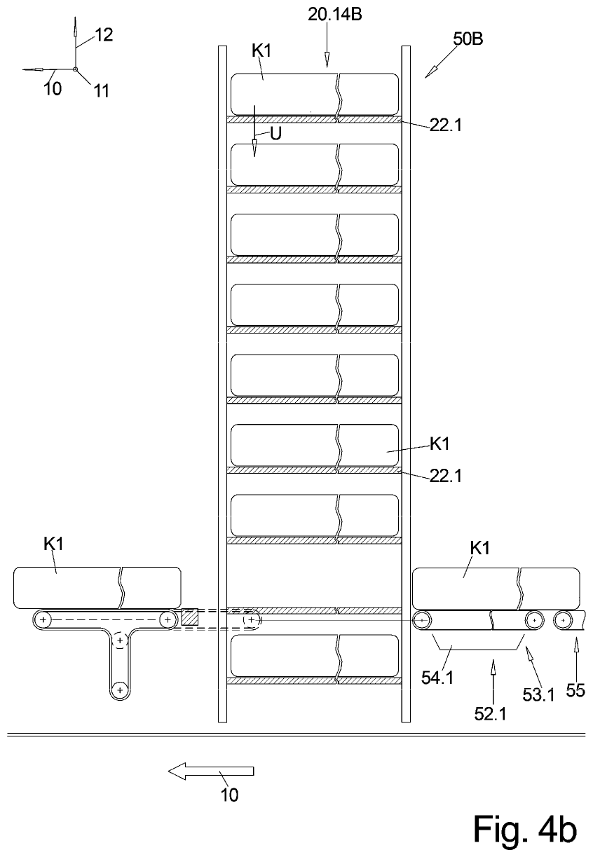

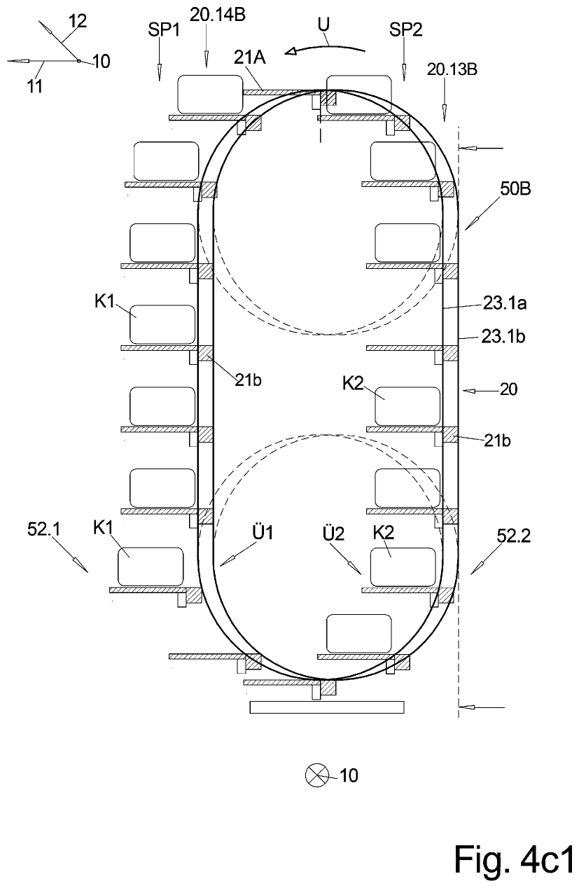

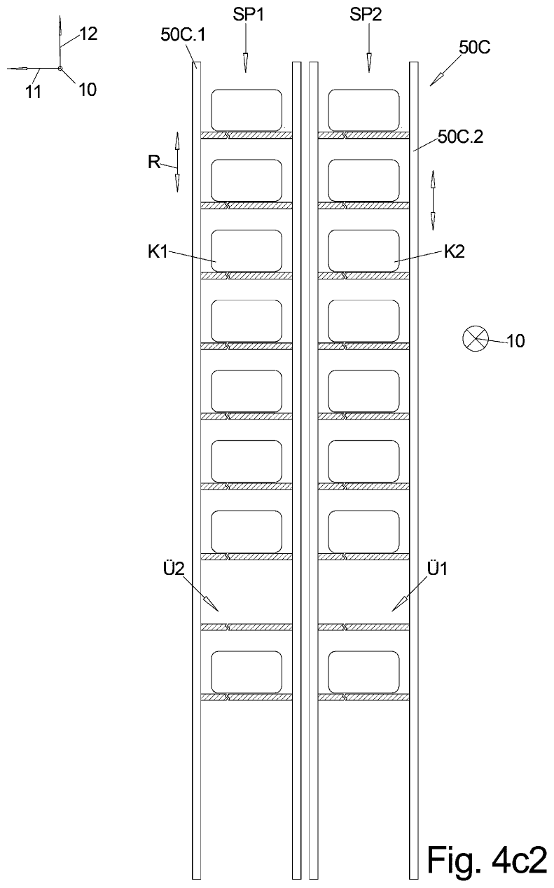

FIG. 4a is a side view according to FIG. 3a, but with the difference that a first run 20.13B and a second run 20.14B of a buffer unit 50B, which is also designed as a paternoster buffer unit 50B, are arranged next to each other when viewed in the feed direction 10, as can be seen, for example, in FIG. 4c1. The exemplary embodiment of the paternoster buffer unit 50B according to FIG. 4a can therefore have a substantially shorter extension in the feed direction 10 than the exemplary embodiment of the paternoster buffer unit 50A according to FIG. 3a but be designed to be correspondingly wider in the width direction 11 (see FIG. 4c1).

The transfer of the calibres K1 or K2 can take place at a transfer position 01 to the first track SP1 or a transfer position Ü2 to the second track SP2, as shown in FIG. 4c1. The loading units 52.1 and 52.2, for example in the form of weighing and transport belts 54.1 and 54.2, and the removal belts 56.1 and 56.2 can therefore be arranged according to the transfer positions Ü1 to the first track SP1 or the transfer position Ü2 to the second track SP2, in order to be able to load the calibres K1, K2 into the buffer unit 50B and remove them therefrom. The calibre receiving units 22.1 can each be moved in the direction of rotation U until a desired calibre receiving unit 22.1 is in the transfer position Ü1 or Ü2.

Finally, FIG. 4c2 shows a rear view of a slicing machine 1 according to FIG. 4a, wherein the buffer storage unit is designed as a two-track compartment storage unit 50C, the compartments of which are arranged according to tracks SP1 and SP2 and can be displaced translationally in and against a displacement direction R. Preferably, each compartment of the buffer unit 50C also comprises a loading unit 22.1 or 22.2, which is configured to receive a product calibre K1 or K2. The compartments or loading units 22.1 of a first compartment unit 50C.1 are preferably movable in and against the displacement direction R independently of compartments or loading units 22.2 of a second compartment unit 50C.2 of the buffer unit 50C, in order to be moved to transfer position Ü1 or Ü2 in each case. The buffer unit 50C according to FIG. 4c2 thus has a comparatively small extension in the width direction 11, but corresponding installation space must be available in the height direction 12 in order to be able to move the buffer unit 50C upwards or downwards in the displacement direction R.

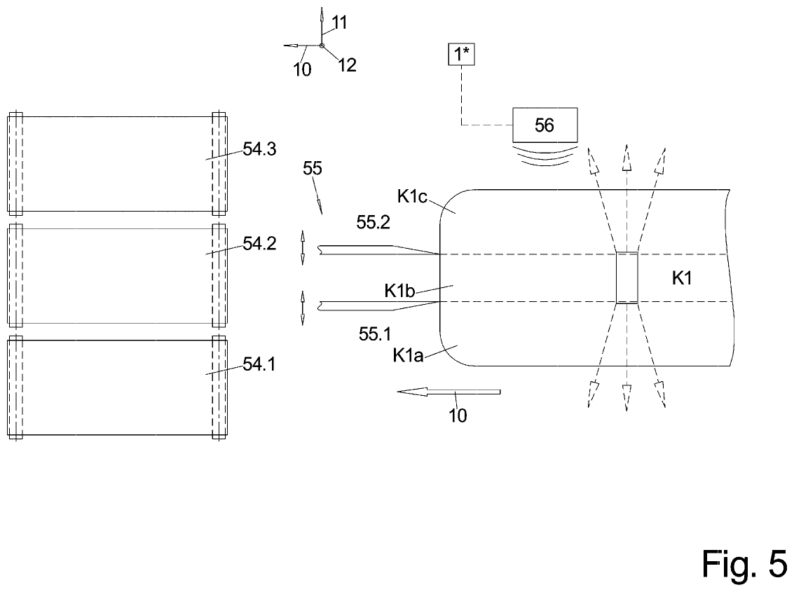

It is further conceivable that the product calibres K1, K2 must first be divided, for example in the width direction 11, into parts of the same weight as possible before slicing, so that the sliced slices S have a desired weight or desired dimensions, in particular with regard to a slice width and/or a slice height. In practice, this is the case with cheese, for example, which is often produced in so-called “Euro blocks”, which must first be cut into several product calibre parts before slicing in order to achieve the dimensions in terms of a slice width of the slices S. Therefore, the slicing machine 1 may preferably comprise at least one cutting device 55, as shown, for example, in FIGS. 3b and 5.

The cutting device 55 can be operatively connected to the controller 1* and be configured to cut a product calibre, for example the product calibre K1 in the longitudinal direction 10, into a plurality of product calibre parts K1a, K1b, K1c, as can be seen in FIG. 5. For this purpose, the cutting device 55 may comprise two cutting elements in the form of cutting blades 55.1 and 55.2 that are adjustable in the transverse direction 11. The cutting device 55 can be arranged upstream of the buffer unit 50A, 50B, 50C in the feed direction 10.

The controller 1* may further preferably be configured to control the cutting device 55 as a function of at least one further product parameter of the product calibre K1, K2, which is detected by a further detection unit 56, which is operatively connected to the controller 1* and configured to detect the at least one further product parameter, in particular a length and/or a volume and/or a shape, of the product calibre K1, K2, so that, for example, the product calibre K1 can be divided into product calibre parts K1a, K1b and K1c of preferably equal weight before it is buffered in the buffer unit 50A, 50B, 50C. It is also understood that the product calibre K2 can be divided into product calibre parts of approximately the same weight in the same manner. Subsequently, the product calibre parts K1a, K1b and K1c can be weighed by means of weighing and transport belts 54.1, 54.2 and 54.3 and fed to the buffer unit 50A, 50B or 50C. The further detection unit 56 is merely schematically indicated in FIG. 5 and can, for example, be an optical sensory system, such as an X-ray sensor, a camera or similar.

### LIST OF REFERENCE NUMBERS

1 slicing machine, slicer
1* controller
2 base framework
3 blade
3′ axis of rotation
3″ blade plane, cutting plane
3a cutting edge
4 feed conveyor, feed belt
4′ pivot axis
5 cutting goggles
6a-d goggle opening
7 cutting unit
8 upper product guide, upper guide belt
9 lower product guide, lower guide belt
10 feed direction
10* direction of travel through machine
11 1st transverse direction (width slicer)
12 2nd transverse direction (height-direction calibre)
12* vertical
13 gripper unit, gripper carriage
14,14 a-d gripper
15 spacer
15′ bearing surface
15″ feed level
16 gripper claw
17 discharge unit
17a, b, c portioning belt, conveyor
18 gripper guide
20 feed unit
20.13A, B, A′ first run
20.14A, B second run
21 remnant piece conveyor
22.1, 22.2 calibre receiving unit
22.1a base body
22.1b receiving element
23.1a, b tension element
50A, B, C temporary storage unit
50C.1 first compartment unit
50C.2 second compartment unit
52.1 loading unit
53.1 weight detection unit
54.1 weighing and transport belt
55 cutting device
56 further detection unit
56.1, 56.2 removal device, removal conveyor
56.1a conveyor band
K, K1, K2 product, product calibre
KR remnant piece
S slice
SP1, 2, 3, 4 track
P portion
U direction of rotation
Ü1, Ü2 transfer position

What is claimed is:

1. A slicing machine for slicing a predetermined number of product calibres into slices and for producing portions from the slices, the slicing machine comprising:
a cutting unit with a blade for separating the slices from the predetermined number of product calibres,
a feeding unit with a feed conveyor for feeding a plurality of product calibres to the cutting unit along a feed direction,
a buffer unit arranged at or upstream of the feeding unit and configured to receive the plurality of product calibres,
a weight detection unit configured to detect a product calibre weight of each of the plurality of product calibres received in the buffer unit, and
a controller operatively connected to the buffer unit and the weight detection unit,
wherein the controller is configured to
obtain from the weight detection unit the product calibre weight of each of the plurality of product calibres received in the buffer unit, and
control the buffer unit to feed the predetermined number of product calibres from the plurality of product calibres to the feeding unit sequentially or simultaneously such that the product calibre weight of each of the predetermined number of product calibres has at most a predetermined deviation from the product calibre weight of each other of the predetermined number of product calibres.

2. The slicing machine according to claim 1 wherein:
the predetermined deviation of the product calibre weights of the predetermined number of product calibres is at most ±4.5%.

3. The slicing machine according to claim 1 wherein:
the controller is further configured to, when the plurality of the product calibres includes more than the predetermined number of product calibres having product calibre weights with at most the predetermined deviation from each other, control the buffer unit to feed the predetermined number of product calibres to the feeding unit sequentially or simultaneously such that a deviation of the product calibre weight of each of the predetermined number of product calibres from the product calibre weight of each other of the predetermined number of product calibres is minimized.

4. The slicing machine according to claim 1 wherein:
the slicing machine further comprises a further detection unit operatively connected to the controller and configured to detect at least one further product parameter comprising a length and/or a volume and/or a shape of the product calibres,
wherein the controller further configured to control the buffer unit as a function of the at least one further product parameter.

5. The slicing machine according to claim 4 wherein:
the slicing machine further comprises a cutting device operatively connected to the controller and configured to cut the product calibres in the longitudinal direction into a plurality of product calibre parts,
wherein the cutting device at least two cutting elements adjustable in the transverse direction,
wherein the controller is further configured to control the cutting device as a function of the at least one further product parameter detected by the further detection unit.

6. The slicing machine according to claim 5 wherein:
the controller is further configured to control the cutting device as a function of at least one product parameter limit value comprising a minimum slice width of the slices and/or a maximum slice width of the slices.

7. The slicing machine according to claim 4 wherein:
the weight detection unit or the further detection unit is arranged upstream of the buffer unit.

8. The slicing machine according to claim 1 further comprising:
a loading unit arranged upstream of the buffer unit and configured to load the plurality of product calibres into the buffer unit through a supply opening of the buffer unit,
wherein the loading unit is designed to be functionally unified with the weight detection unit and/or the further detection unit, and/or
the weight detection unit is designed as a weighing and/or transport belt.

9. The slicing machine according to claim 1 further comprising:
at least one removal device configured to remove a relevant product calibre from the buffer unit and to convey the relevant product calibre onto the feed conveyor of the feeding unit,
wherein the removal device is further configured to push the relevant product calibre onto the feed conveyor of the feeding unit in parallel with the feed direction.

10. The slicing machine according to claim 1 wherein:
the buffer unit is designed as a paternoster buffer unit comprising a plurality of calibre receiving units,
wherein the plurality of calibre receiving units is displaceable in and/or against a direction of rotation by a drive unit of the buffer unit, or
the buffer unit is designed as a compartment buffer unit, which comprises a plurality of calibre receiving units in the form of calibre compartments,
wherein the plurality of calibre receiving units is displaceable in and/or against a height direction by a drive unit of the buffer unit.

11. The slicing machine according to claim 1 wherein:
the buffer unit comprises a cooling unit configured to passively or actively cool the plurality of the product calibres accommodated therein.

12. A method for slicing a predetermined number of product calibres into slices and for producing portions from the slices by a slicing machine, the method comprising:
feeding the predetermined number of product calibres along a feeding direction by a feeding conveyor of a feeding unit,
cutting off slices from front ends of the predetermined number of product calibres by a cutting unit,
storing the slices on a portioning belt for producing portions having one or more slices wherein:
before feeding, storing temporarily a plurality of product calibres in a buffer unit,
detecting a product calibre weight of each of the plurality of product calibres by a weight detection unit, and
feeding the predetermined number of product calibres from the plurality of product calibres in the buffer unit sequentially or simultaneously to the feeding unit such that the product calibre weight of each of the predetermined number of product calibres has at most a predetermined deviation from the product calibre weight of each other of the predetermined number of product calibres.

13. The method according to claim 12 wherein:
the predetermined deviation of the product calibre weights of the predetermined number of product calibres is at most ±4.5%.

14. The method according to claim 12 further comprising:
when the plurality of the product calibres includes more than the predetermined number of product calibres having product calibre weights with at most the predetermined deviation from each another, feeding the predetermined number of product calibres sequentially or simultaneously to the feeding unit such that a deviation of the product calibre weight of each of the predetermined number of product calibres from the product calibre weight of each other of the predetermined number of product calibres is minimized.

15. The method according to claim 12 further comprising:
detecting at least one further product parameter comprising a length and/or a volume and/or a shape of the plurality of product calibres,
wherein storing the plurality of product calibres and/or feeding of the predetermined number of product calibres is further performed as a function of the at least one further product parameter.

16. The method according to claim 12 further comprising:
before storing, cutting the plurality product calibres in a longitudinal direction by a cutting device into a plurality of product calibre parts,
wherein cutting of the plurality of product calibres is controlled as a function of the at least one further product parameter, and/or
wherein cutting of the plurality of product calibres is controlled as a function of at least one product parameter limit value comprising a minimum slice width of the slices and/or a maximum slice width of the slices.
